(19) United States
(12) Patent Application Publication
(10) Pub. No.: US 2025/0266933 A1
(43) Pub. Date: Aug. 21, 2025

(54) SECONDARY HARQ FEEDBACK RESOURCE ALLOCATION FOR SIDELINK COMMUNICATION IN UNLICENSED SPECTRUM

(71) Applicant: Nokia Technologies Oy, Espoo (FI)

(72) Inventors: Timo Erkki LUNTTILA, Espoo (FI); Yong LIU, Shanghai (CN); Renato Barbosa ABREU, Aalborg (DK); Naizheng ZHENG, Beijing (CN); Jianguo LIU, Shanghai (CN); Laura Luque SANCHEZ, Aalborg (DK); Ling YU, Espoo (FI)

(21) Appl. No.: 18/857,798

(22) PCT Filed: Apr. 21, 2022
(86) PCT No.: PCT/CN2022/088099

§ 371 Date: Oct. 17, 2024

(51) Int. Cl. H04L 1/1812; H04W 72/0453; H04W 72/25

(52) U.S. Cl. CPC H04L 1/1812; H04W 72/0453; H04W 72/25

(57) ABSTRACT

Example embodiments relate to secondary HARQ feedback resource allocation for sidelink communication in unlicensed spectrum. An apparatus may receive a sidelink transmission from a user equipment, determine a hybrid automatic retransmission request (HARQ) feedback regarding the sidelink transmission, determine whether a primary resource for transmitting the HARQ feedback is available, and determine a secondary resource for transmitting the HARQ feedback when the primary resource is unavailable.

### TECHNICAL FIELD

Exemplary embodiments described herein generally relate to communication technologies, and more particularly, to apparatuses and methods for secondary hybrid automatic retransmission request (HARQ) feedback resource allocation in sidelink communications over unlicensed spectrum.

### BACKGROUND

5G New Radio (NR) supports sidelink to provide reliable, low latency and high-speed device-to-device (D2D) communications for various applications especially in vehicle-to-everything (V2X) scenarios. In NR sidelink, a user equipment (UE) may transmit to one or more UEs by unicast, groupcast or broadcast under or without control of the network. A hybrid automatic retransmission request (HARQ) mechanism is also introduced in NR sidelink to ensure reliability of the sidelink transmissions.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of an apparatus is provided. The apparatus may comprise at least one processor and at least one memory including computer program code. The at least one memory and the computer program code may be configured to, with the at least one processor, cause the apparatus at least to receive a sidelink transmission from a user equipment, determine a hybrid automatic retransmission request (HARQ) feedback regarding the sidelink transmission, determine whether a primary resource for transmitting the HARQ feedback is available, and determine a secondary resource for transmitting the HARQ feedback when the primary resource is unavailable.

In a second aspect, an example embodiment of an apparatus is provided. The apparatus may comprise at least one processor and at least one memory including computer program code. The at least one memory and the computer program code may be configured to, with the at least one processor, cause the apparatus at least to transmit a sidelink transmission to a user equipment, determine whether a primary resource for receiving a hybrid automatic retransmission request (HARQ) feedback regarding the sidelink transmission is available, and determine a secondary resource for receiving the HARQ feedback when the primary resource is unavailable.

Example embodiments of methods, apparatus and computer program products are also provided. Such example embodiments generally correspond to the above example embodiments, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a communication network in which example embodiments of the present disclosure can be implemented.

FIGS. 2A and 2B are schematic diagrams illustrating example sidelink slots with and without a physical sidelink feedback channel symbol, respectively.

FIG. 3 is a schematic diagram illustrating an example mapping of a physical sidelink shared channel to a physical sidelink feedback channel.

FIG. 4 is a schematic diagram illustrating a channel occupancy time (COT) duration obtained through a listen before talk (LBT) procedure.

FIG. 5 is a schematic message flow chart illustrating sidelink communications between multiple UEs.

FIG. 6 is a schematic diagram illustrating an example of hybrid automatic retransmission request (HARQ) feedback blocked due to LBT failure for sidelink over unlicensed spectrum (SL-U).

FIG. 7 is a schematic diagram illustrating an example of secondary physical sidelink feedback channel (PSFCH) resource allocation according to an example embodiment of the present disclosure.

FIG. 8 is a schematic message flow chart illustrating a procedure of secondary PSFCH resource allocation according to an example embodiment of the present disclosure.

FIG. 9 is a schematic diagram illustrating an example of secondary PSFCH resource allocation according to an example embodiment of the present disclosure.

FIG. 10 is a schematic diagram illustrating an example of secondary PSFCH resource allocation according to an example embodiment of the present disclosure.

FIG. 11 is a schematic message flow chart illustrating a procedure of transmitting a HARQ feedback based on secondary PSFCH resource according to an example embodiment of the present disclosure.

FIG. 12 illustrates a schematic block diagram of a device according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

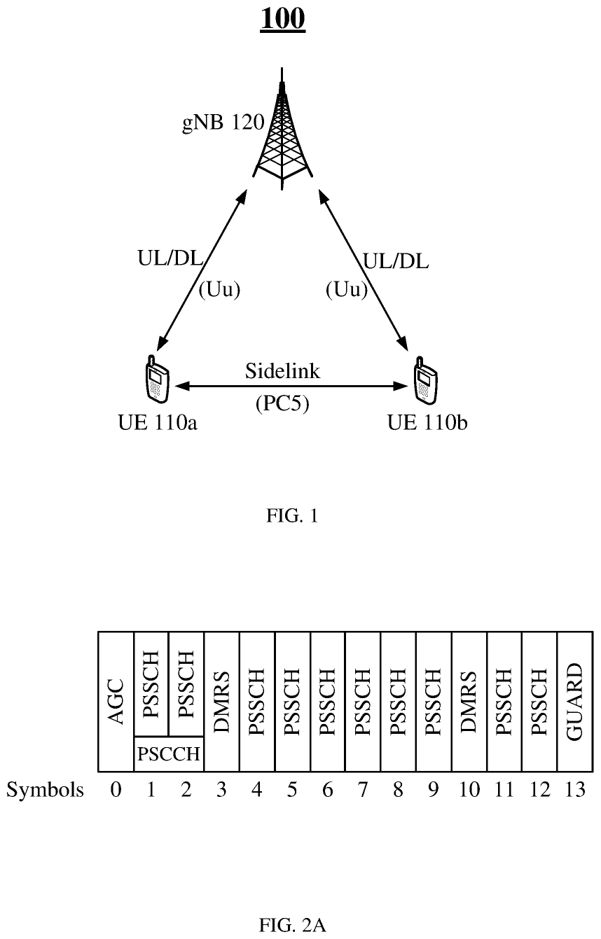

FIG. 1 illustrates an example communication network 100 in which exemplary embodiments of the present disclosure can be implemented. Referring to FIG. 1, the communication network 100 may include a first UE 110a, a second UE 110b and a base station (BS) 120. The base station 120 is shown as a 5G base station gNB in FIG. 1 but it may also be implemented as a Long Term Evolution (LTE) base station eNB or a beyond 5G base station. The base station 120 may communicate with the UEs 110a, 110b via uplink (UL) and downlink (DL) over a Uu interface. In other examples, the base station 120 may implement other radio access technologies to communicate with the UEs 110a, 110b.

The UEs 110a, 110b may be a vehicle mounted terminal, a roadside unit, a mobile phone, and the like. In addition to the network communications over the Uu interface with the base station 120, the UEs 110a, 110b may also perform direct communications, referred to as sidelink (SL) communications, to each other over for example a PC5 interface. The UEs 110a, 110b each may function as a SL transmitter (TX) UE to transmit information on the sidelink or a SL receiver (RX) UE to receive information on the sidelink. The SL TX UE may transmit to one or more SL RX UEs by unicast, groupcast or broadcast under or without control of the network. For example, the sidelink may be established between the UEs 110a, 110b of which both are within the network coverage (in-coverage scenario), both are outside the network coverage (out-of-coverage scenario), or one is within the network coverage and the other is outside of the network coverage (partial-coverage scenario).

The UEs 110a, 110b may use same or different spectrum for the network communications over the Uu link and the sidelink communications on the sidelink. In some example embodiments, the UEs 110a, 110b may perform network communications in a licensed spectrum e.g. LTE or NR bands, and perform sidelink communications in an unlicensed spectrum. The unlicensed spectrum may refer to any frequency band(s) that does not require a license from an appropriate regulating entity, such that the frequency band(s) are open to use by any devices, not just devices that have a license to use the particular frequency band(s). Examples of the unlicensed spectrum that have worldwide availability include 2.4 GHz, 5 GHz and 60 GHz.

Two radio resource allocation modes are designed in 3GPP specifications, and an SL TX UE may be configured with one of them to perform its sidelink transmissions. In Mode 1, the network is responsible for sidelink transmission resource allocation to the SL TX UE. The SL TX UE may transmit a sidelink scheduling request (SL-SR) to the base station 120, and the base station 120 may send a resource allocation to the SL TX UE in response to the received SL-SR. In Mode 2, the SL TX UE can autonomously select its sidelink transmission resources. For example, the SL TX UE may first perform a sensing procedure over a configured sidelink transmission resource pool(s), in order to obtain the knowledge of the reserved resource(s) by other nearby SL TX UE(s). Based on the knowledge obtained from the sensing procedure, the SL TX UE may select resource(s) from the available SL resources, accordingly.

In order for a SL UE to perform sensing and obtain necessary information to receive a SL transmission, the SL UE needs to decode sidelink control information (SCI). The SCI associated with a data transmission may have a two stage SCI structure, including a first stage SCI and a second stage SCI, to support a size difference between SCIs for various NR V2X sidelink service types e.g. broadcast, groupcast and unicast. The first stage SCI, including SCI format 1-A, may be carried by a physical sidelink control channel (PSCCH) and contain information to enable the sensing operations and information needed to determine resource allocation of a physical sidelink shared channel (PSSCH) and to decode the second stage SCI, among others. The second stage SCI, including SCI format 2-A and 2-B, may be carried by the PSSCH and contain source and destination identities, information to identify and decode an associated sidelink shared channel (SL-SCH) transport block (TB), control information of HARQ feedback, and trigger information for channel state information (CSI) feedback, among others.

The configuration of the resources in the sidelink resource pool defines the minimum information required for the SL RX UE to be able to decode a sidelink transmission, which includes the number of sub-channels, the number of physical resource blocks (PRBs) per sub-channel, the number of symbols in the PSCCH, and slots having a physical sidelink feedback channel (PSFCH), among others. The details of the actual sidelink transmission, i.e. the payload sent within the PSSCH, are provided in the PSCCH (the first stage SCI) for each individual transmission, which may include time and frequency resources, demodulation reference signal (DMRS) configuration of the PSSCH, the modulation and coding scheme (MCS), the PSFCH, among others. The SL RX UE needs to decode the PSCCH before decoding the payload of the sidelink transmission.

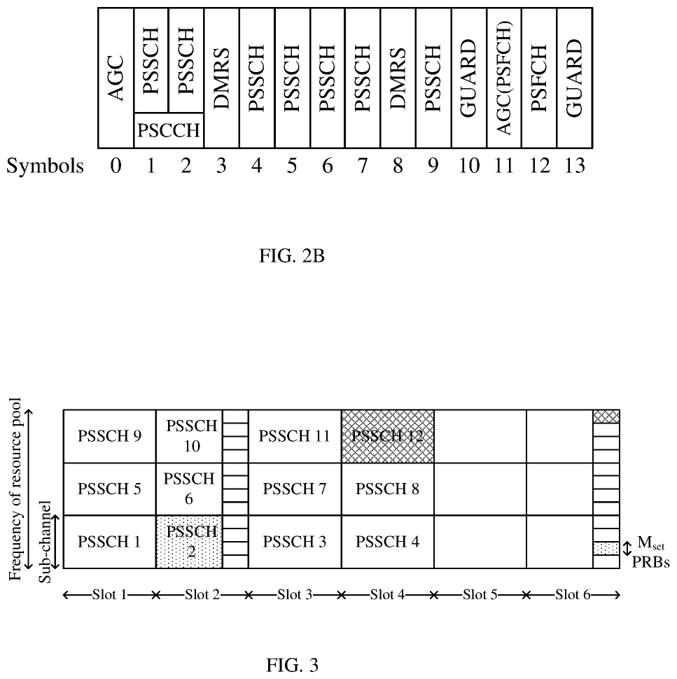

FIG. 2A illustrates an example sidelink slot including PSCCH and PSSCH symbols, and FIG. 2B illustrates an example sidelink slot including PSCCH, PSSCH and PSFCH symbols. In both slots, the first symbol (symbol #0) is used for automatic gain control (AGC), which may be a duplicated symbol of the second symbol (symbol #1), and the last symbol (symbol #13) is used for a guard period (GP). The PSCCH may be transmitted in the second and third symbols (symbols #1, #2). When the HARQ feedback is enabled, the second last symbol (symbol #12, the last symbol except for the guard symbol #13) may be used for the PSFCH, and a guard symbol (symbol #10) may be included between the PSSCH symbols and the PSFCH symbol. The symbol before the PSFCH symbol may also be used for AGC, which may be a duplicated symbol of the PSFCH symbol. As mentioned above, the configuration of the PSCCH (e.g., DMRS, MCS, number of symbols used) is part of the resource pool configuration, and the indication of which slots have PSFCH symbols is also part of the resource pool configuration. The configuration of the PSSCH (e.g., the number of symbols used, the DMRS pattern and the MCS) is provided by the first stage SCI which is the payload sent within the PSCCH.

The PSFCH is introduced to enable HARQ feedback over the sidelink from a UE that is the intended recipient of a PSSCH transmission (i.e., the RX UE) to a UE that performed the transmission (i.e., the TX UE). If the RX UE receives and decodes the PSSCH transmission successfully, it generates a positive HARQ acknowledgement (ACK) and sends the HARQ ACK on the PSFCH to the TX UE to confirm the transmission. If the RX UE fails to receive or decode the PSSCH transmission, it generates a negative HARQ acknowledgement (NACK) and sends the HARQ NACK on the PSFCH to the TX UE to request a retransmission of the PSSCH. In NACK-only HARQ feedback, the RX UE may not send the HARQ ACK feedback when it successfully receives and decodes the PSSCH transmission. The Rx UE is always aware when the PSSCH transmission is intended to it, e.g., based on the TX and RX IDs indicated in the second stage SCI. Within the PSFCH, a Zadoff-Chu sequence in one PRB is repeated over two OFDM symbols, the first of which can be used for AGC, near the end of the sidelink resource in a slot as shown in FIG. 2B. The Zadoff-Chu sequence, as a base sequence, is configured or pre-configured per sidelink resource pool.

The time resources for PSFCH may be configured or pre-configured to occur once every N slots where N may have a value of 0, 1, 2, 4 or others. The HARQ feedback resource (PSFCH) is derived from the resource location of the PSSCH. A parameter K in unit of slot is configured for PSSCH-to-HARQ timing, and the time occasion for PSFCH may be determined from the parameter K. For example, for a PSSCH transmission with its last symbol in slot n, its HARQ feedback is expected in slot n+a where a is the smallest integer larger than or equal to K, with the condition that the slot n+a contains PSFCH resources. The time gap of at least K slots allows considering the RX UE's processing delay in decoding the PSCCH, the PSSCH and generating the HARQ feedback. The parameter K may have a value of 2, 3, 4 or others, and a single value of K can be configured or pre-configured per resource pool. This allows several RX UEs using the same resource pool to utilize the same mapping of PSFCH resources for the HARQ feedback. With the parameter K, the N PSSCH slots associated with a slot with PSFCH can be determined.

FIG. 3 illustrates an example mapping of PSSCH slots to a PSFCH slot. Referring to FIG. 3, the PSFCH periodicity is configured as N=4, and the PSSCH-to-HARQ time gap is configured as K=2 e.g. via an information element s/-MinTimeGapPSICH. As such, there will be 4 PSSCH slots associated with the PSFCH, and the time gap from the last PSSCH to the PSFCH is 2 slots. With L sub-channels in a resource pool and N PSSCH slots associated with a slot containing PSFCH, there are then N*L PSSCH transmissions associated with a PSFCH symbol. With M PRBs available for PSFCH in the PSFCH symbol, there are M PRBs available for the HARQ feedback of PSSCH transmissions over the I. sub-channels and the N slots. Then a distinct set of Mₛₑₜ=M/(N*L) PRBs can be associated with the HARQ feedback for each PSSCH transmission, within a PSFCH period, where M is configured to be a multiple of N*L. The first set of Mₛₑₜ PRBs among the M PRBs available for PSFCH is associated with the HARQ feedback of the PSSCH transmission in the first sub-channel in the first slot, the second set of Mₛₑₜ PRBs among the M PRBs is associated with the HARQ feedback of the PSSCH transmission in the first sub-channel in the second slot, and so on.

In the example shown in FIG. 3, the resource pool is configured with L=3 sub-channels and all PRBs in the PSFCH symbol are available for the PSFCH. There are twelve PSSCH transmissions over the/=3 sub-channels and N=4 slots, and the HARQ feedback for the PSSCH transmission x is sent on the x-th set of Mₛₑₜ PRBs in the corresponding PSFCH symbol, with x=1, . . . , 12.

A set of Mₛₑₜ PRBs associated with a sub-channel may be shared among multiple RX UEs in case of ACK/NACK feedback for groupcast communications or in case of different PSSCH transmissions in the same sub-channel. For each PRB available for the PSFCH, there are (cyclic shift pairs available to support the ACK or NACK feedback of (RX UEs within the PRB. For a resource pool, the number of cyclic shift pairs (may be configured or pre-configured with a value of 1, 2, 3, 6 or others.

There are F PSFCH resources available for supporting the HARQ feedback of a given transmission. With each PSFCH resource used by one RX UE, the F PSFCH resources can be used for the ACK/NACK feedback of up to F RX UEs. The F PSFCH resources available for multiplexing the HARQ feedback for the PSSCH can be determined based on two options:
a) either based on the L PSSCH sub-channels used by the PSSCH, where I can be computed as:
   F=L*Mₛₑₜ*Q) where the FPSFCH resources are associated with/sub-channels of the PSSCH;
b) or based only on the starting sub-channel used by the PSSCH (i.e., based only on one sub-channel for the case when L>1), where F can be computed as:
   F=Mₛₑₜ*Q) where the F PSFCH resources are associated with the starting sub-channel of the PSSCH.

Similar to the physical uplink control channel (PUCCH) over the NR Uu interface, the available F PSFCH resources may be indexed based on a PRB index (frequency domain) and a cyclic shift pair index (code domain). The mapping of the PSFCH index i (i=1, 2, . . . , F) to the PRBs and to the (cyclic shift pairs is such that the PSFCH index i first increases with the PRB index until reaching the maximum number of available PRBs for the PSFCH. Then, the PSFCH index i increases with the cyclic shift pair index, again with the PRB index, and so on. Among the F PSFCH resources available for the HARQ feedback of a given transmission, the RX UE may select for its HARQ feedback the PSFCH resource with index i given by:
i=(T_{ID}+R_{ID}) mod/′ where Tin is the Layer 1 ID of the TX UE indicated in the second stage SCI, R_{ID}=0 for unicast ACK/NACK feedback and groupcast NACK-only feedback (option 1) or R_{ID} is equal to the RX UE identifier within a group, which is indicated by higher layers, for groupcast ACK/NACK feedback (option 2).

For a number X of RX UEs within a group, the RX UE identifier may be an integer between 0 and X-1. An RX UE may determine which PRB and cyclic shift pair will be used for sending its HARQ feedback based on the PSFCH index i. The RX UE may use the first or second cyclic shift from the cyclic shift pair associated with the selected PSFCH index i in order to send NACK or ACK, respectively. By the RX UEs selecting PSFCHs with index i, a TX UE can distinguish the HARQ feedback from different RX UEs (via the RX UE identifier, e.g., for groupcast option 2) and the HARQ feedback intended for the TX UE (via the Layer 1 ID of the TX UE, e.g. for unicast). As R_{ID}=0 for groupcast option 1, the RX UEs can select the same PSFCH index i for their NACK-only feedback based solely on the Layer 1 TX UE identifier T_{ID}.

As mentioned above, the sidelink communications may be performed in an unlicensed spectrum which may also be used by other communication systems. For example, 2.4 GHz and 5 GHz frequency bands are also used for WiFi communication. Considering coexistence with other systems (e.g. IEEE 802.11), a TX UE needs to perform a clear channel assessment procedure to evaluate whether the channel resources, which may be obtained by resource allocation Mode 1 or Mode 2, are available for a sidelink transmission or not. A Listen Before Talking (LBT) channel access mechanism is introduced for the channel availability assessment where a UE intending to perform a sidelink transmission needs first to successfully complete an LBT check before being able to initiate the transmission. For the UE to pass the LBT check, the UE observes the channel as available for a number of consecutive Clear Channel Assessment (CCA) slots. In sub-7 GHz unlicensed bands the duration of these slots may be 9 μs. The TX UE deems the channel as available in a CCA slot if the measured power (i.e. the collected energy during the CCA slot) is below a predetermined threshold which can depend on the operating band and geographical region.

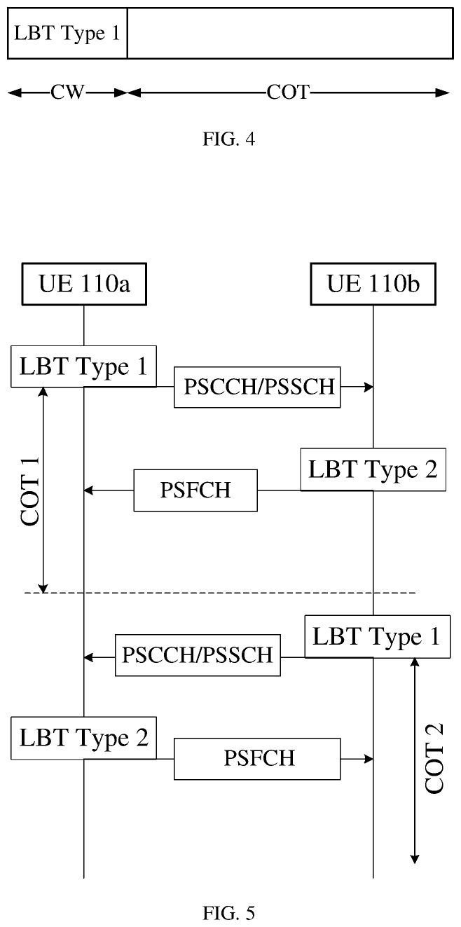

When a UE initiates the sidelink communication (i.e. the UE takes the role of initiating device), then this UE has to acquire the “right” to access the channel for a certain period of time, referred to as Channel Occupancy Time (COT), by applying an “extended” LBT procedure where the channel is deemed as free for the entire duration of a Contention Window (CW). This “extended” LBT procedure is commonly known as LBT Type 1 (or LBT Cat. 4). An example of the contention window and the channel occupancy time is illustrated in FIG. 4. The duration of the COT and CW may depend on Channel Access Priority Class (CAPC) associated with the UE's traffic. Control plane traffic (such as PSCCH) may have CAPC=1, while user plane traffic may have CAPC>1.

Upon successfully completing the LBT Type 1 and performing a transmission, the UE (initiating device) acquires the COT with duration associated with the corresponding CAPC. The acquired COT is valid even in a case where the initiating device pauses its transmission. If the initiating device wants to perform a new transmission within the COT, it is still required to perform a “reduced” LBT procedure. The “reduced” LBT procedure, is commonly known as LBT Type 2, with the following variants:
Type 2A (25 μs LBT, also referred to as LBT Cat. 2)—for sidelink transmissions within the initiating device acquired COT (in case a gap between two sidelink transmissions is larger than or equal to 25 μs, as well for sidelink transmissions following another sidelink transmission);
Type 2B (16 μs LBT, also referred to as LBT Cat. 2)—for sidelink transmissions within the initiating device acquired COT (only used for sidelink transmissions following another sidelink transmission with a gap equal to 16 μs); and
Type 2C (no LBT, also referred to as LBT Cat. 1)—for sidelink transmission following another sidelink transmission with a gap less than 16 us and the allowed duration of the sidelink transmission is less than or equal to 584 μs.

The initiating device can share its acquired COT with its intended receiver (the responding device). For this purpose, the initiating device may inform e.g. via control signaling the responding device about the duration of the COT. Then the responding device may use this information to decide which type of LBT it should apply upon performing a transmission for which the intended receiver is the initiating device. In case the responding device's transmission falls outside the COT, then the responding device will have to acquire a new COT using the LBT Type 1 with the appropriate CAPC.

FIG. 5 illustrates an example of sidelink communications between multiple UEs. Referring to FIG. 5, a first UE 110a may transmit PSCCH/PSSCH to a second UE 110b when the first UE 110a obtains a first COT by performing “extended” LBT (LBT Type 1). The first UE 110a may also share the first COT with the second UE 110b via control signaling. Within the first COT, the second UE 110b may perform a “reduced” LBT (LBT Type 2) to confirm channel availability and transmit PSFCH to the first UE 110a, in response to the PSCCH/PSSCH received from the first UE 110a. If the second UE 110b wants to send a transmission to the first UE 110a but the first COT has expiries, the second UE 110b may perform LBT Type 1 to obtain a second COT and then transit PSCCH/PSSCH to the first UE 110a. The second UE 110b may also share the second COT with the first UE 110a via control signaling. Within the second COT, the first UE 110a may perform LBT Type 2 to confirm channel availability and transmit PSFCH to the second UE 110b, in response to the PSCCH/PSSCH received from the second UE 110b.

Because of the listen-before talk requirements, when operating on unlicensed spectrum there will be some uncertainty on whether a given transmission can take place when intended, or not. This is affecting especially procedures where a fixed timing relationship is assumed between two or more transmissions. One such example is HARQ procedure, where for a PSSCH transmission with its last symbol in slot n, HARQ feedback transmission is expected in slot n+a where a is the smallest integer larger than or equal to the PSSCH-to-HARQ time gap parameter K with the condition that slot n+a contains PSFCH resources. However, when LBT needs to be performed prior to each channel occupancy at least by the TX UE (transmitting the PSSCH and PSCCH), there is no guarantee that the transmission of HARQ feedback on PSFCH is possible in the slot n+a.

A case may be considered where the RX UE may have no capability of performing LBT, and can only transmit within a channel occupancy initiated by the TX UE. An example of a relevant scenario where this assumption is applicable includes reduced capability devices (i.e. devices without LBT capabilities) such as sensors and actuators, where the communication of these sensors and actuators is always initiated via a controlling device (i.e. a device with LBT capabilities). This is a valid assumption because the implementation of LBT induces significant complexity to a device, as it requires the device to transition from the receiving state (e.g. to perform the LBT) to the transmitting state within a few microseconds.

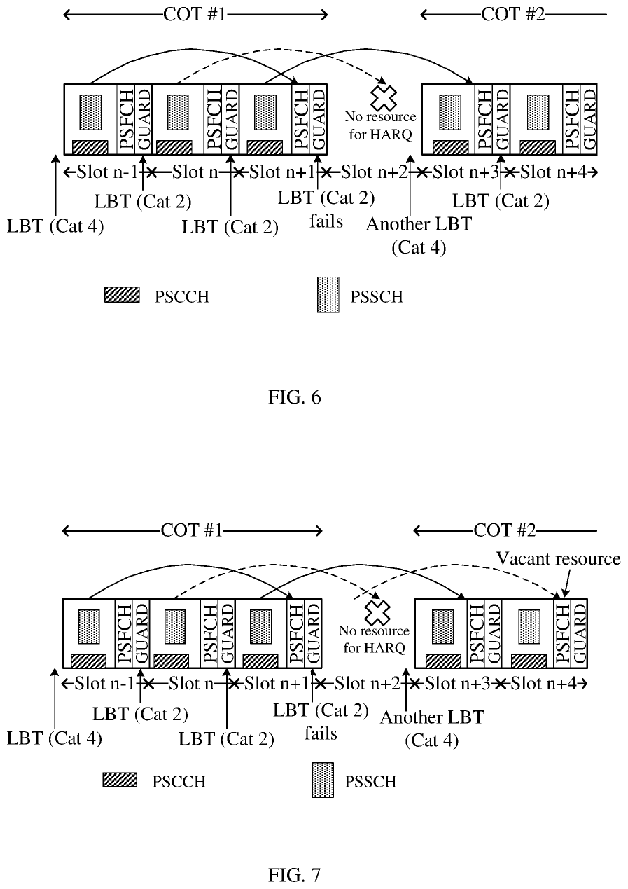

FIG. 6 illustrates an example case where an HARQ feedback is blocked due to LBT failure. Referring to FIG. 6, a TX UE obtains a first COT (COT #1) by performing LBT Type 1 (LBT Cat. 4) and transmits PSCCH/PSSCH to a RX UE in slot n-1. Within the COT, the TX UE also performs LBT Type 2 (LBT Cat. 2) in the guard period between two adjacent slots and transmits PSCCH/PSSCH to the RX UE in subsequent slots. In this example, the PSFCH periodicity is set to N=1 slot and the HARQ delay is set to a=2 slots. Then the RX UE is expected to transmit PSFCH two slots after receiving the corresponding PSCCH/PSSCH. For example, the RX UE transmits PSFCH in slot n+1 in response to the PSCCH/PSSCH received in slot n-1. However, when the LBT Type 2 fails at the end of slot n+1 and the first COT ends, the HARQ feedback that was bound to slot n+2 cannot be delivered because no PSFCH resource is available in slot n+2. The TX UE can perform another LBT Type 1 to obtain a second COT (COT #2) and transmit to the RX UE. Since the PSFCH resource is available in slot n+3, the RX UE can transmit PSFCH in slot n+3 in response to the PSCCH/PSSCH received in slot n+1.

Example embodiments provide a secondary resource allocation mechanism for HARQ feedback on PSFCH that cannot be transmitted on the primary PSFCH resource when intended due to for example LBT failure. The secondary PSFCH resource may be allocated in one or more slots which follow one or more empty slots that do not have transmission because of for example LBT failure. An example of secondary resource allocation is shown in FIG. 7, which illustrate a case similar to that shown in FIG. 6. Referring to FIG. 7, the TX UE suffers a LBT failure before the start of slot n+2 and therefore is not able to perform its PSCCH/PSSCH transmission in slot n+2, which in turn prevents the RX UE from transmitting on the PSFCH in slot n+2 the HARQ feedback for the PSSCH transmission in slot n. Also because of the LBT failed prior to slot n+2, there is no PSSCH transmission in slot n+2, and hence there is no HARQ feedback corresponding to that slot in slot n+4 either, and the PSFCH resources in slot n+4 are unoccupied. Then the unoccupied resources may be used as secondary resources for the HARQ feedback whose transmission failed on the primary resources due to LBT failure.

The example embodiments can be applied to RX UEs which have or do not have LBT capabilities. The secondary PSFCH resources may be allocated in a shared COT initiated by the TX UE (i.e. the UE that transmits the PSCCH/PSSCH), and the RX UE may or may not perform LBT prior to transmission of the PSFCH. The RX UE may determine the secondary PSFCH resources from an explicit indication from the TX UE, or the RX UE may determine the secondary PSFCH resources on its own, e.g. based on predetermined rules. The secondary resource allocation mechanism would not significantly increase signaling overhead for the sidelink communication.

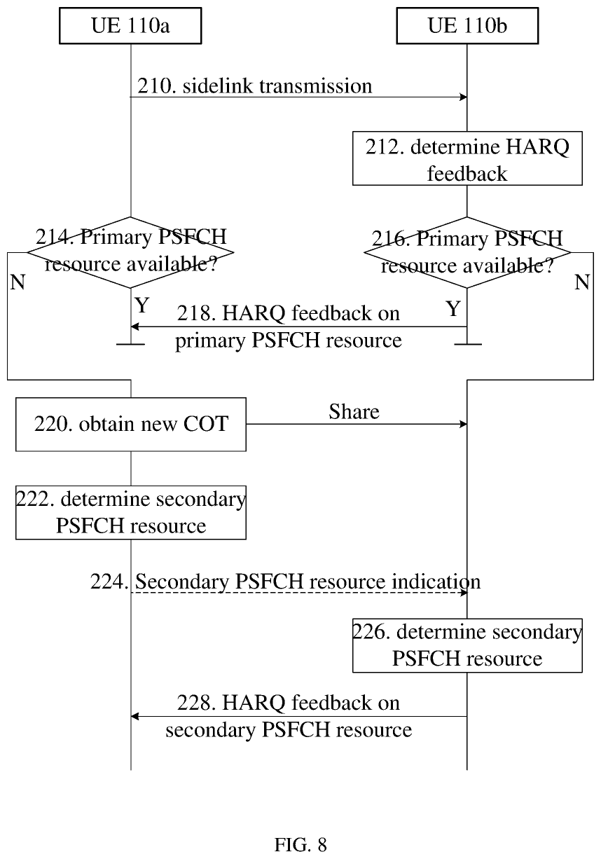

FIG. 8 illustrates a secondary PSFCH resource allocation procedure according to an example embodiment of the present disclosure. The procedure may be performed by UEs which have sidelink capabilities, e.g. the UEs 110a, 110b discussed above with respect to FIG. 1. In some example embodiments, the UE 110a is described as a TX UE and the UE 110b is described as a RX UE, but it would be appreciated that any one of the UEs 110a, 110b can function as both a TX UE and a RX UE. In some example embodiments, the UEs 110a, 110b may include or be configured with a plurality of components, modules, means or elements to perform operations in the procedure, and the components, modules, means or elements may be implemented in various manners including but not limited to for example software, hardware, firmware or any combination thereof.

Referring to FIG. 8, the TX UE 110a may transmit a sidelink transmission to the RX UE 110b at an operation 210. The sidelink transmission may include for example payload carried on PSSCH and information needed to decode the payload carried on PSCCH. The sidelink transmission may be transmitted in unlicensed spectrum and the TX UE 110a may have performed LBT Type 1 or Type 2 before the sidelink transmission. The RX UE 110b is aware whether there is a transmission for it based on e.g. the second stage SCI which includes a source identifier indicating the TX UE and a destination identifier indicating the RX UE. At the operation 210, the RX UE 110b may receive the sidelink transmission and decode the first stage SCI carried on the PSCCH first, and then decode the second stage SCI carried on the PSSCH according to the first stage SCI. With the first and second stage SCI, the RX UE 110b can decode the payload of the sidelink transmission.

At an operation 212, the RX UE 110b may determine an HARQ feedback for the sidelink transmission received in the operation 210. The determined HARQ feedback may be a positive acknowledgement (ACK) to confirm successful receiving and decoding of the sidelink transmission or a negative acknowledgement (NACK) to inform the TX UE 110a that the RX UE 110b fails to decode the sidelink transmission. In response to the HARQ NACK feedback, the TX UE 110a may perform a re-transmission if needed.

The TX UE 110a may determine at 214 whether a primary PSFCH resource for the HARQ feedback in association with the sidelink transmission sent in the operation 210 is available or not. Here the primary PSFCH resource refers to the resource that is determined for normal transmission of the HARQ feedback based on the resource used for the sidelink transmission and the PSFCH channel configuration. For example, the primary PSFCH resource may be determined as discussed above with respect to FIG. 2B and FIG. 3. In an example embodiment, the TX UE 110a may perform a clear channel assessment procedure e.g. a Listen Before Talk (LBT) channel access procedure to evaluate whether the primary PSFCH resource for the HARQ feedback is available or not. At the operation 214, either Cat. 4 LBT or Cat. 2 LBT may be performed to check availability of the primary PSFCH resource.

At an operation 216, the RX UE 110b may also determine whether the primary PSFCH resource for the HARQ feedback determined at the operation 212 is available or not. In an example embodiment where the RX UE 110b is a reduced capacity device that does not implement LBT, the RX UE 110b may detect, based on control signaling received from the TX UE 110a, whether there is a shared channel occupancy initiated by the TX UE 110a available for transmitting the HARQ feedback on the primary PSFCH resource or not. If the RX UE 110b has capability to perform the LBT, the RX UE 110b may, additionally or alternatively, perform the LBT (e.g., Cat. 2 LBT) to check if the primary PSFCH resource is available or not.

If the primary PSFCH resource is available, the RX UE 110b may transmit to the TX UE 110a the HARQ feedback using the primary PSFCH resource at an operation 218. If the received HARQ feedback is HARQ ACK, the TX UE 110a knows that the sidelink transmission was successfully received at the RX UE 110a and it may initiate a new transmission. If the received HARQ feedback is HARQ NACK, the TX UE 110a knows that the RX UE 110a failed to receive the sidelink transmission and it may perform a retransmission if needed.

If the primary PSFCH resource is unavailable, the TX UE 110a may initiate a new channel occupancy time (COT) by performing the “extended” LBT (Cat. 4 LBT) and share the COT with the RX UE 110b, at an operation 220. Here the new COT is referred to as a second COT, and the previous COT for the sidelink transmission at the operation 210 is referred to as a first COT. Before the “extended” LBT for the second COT, the TX UE 110a may select any available resources, e.g. any future slot and sub-channel(s) combination. In an example, the TX UE 110a may select the available resources based on the Mode 2 resource selection procedure.

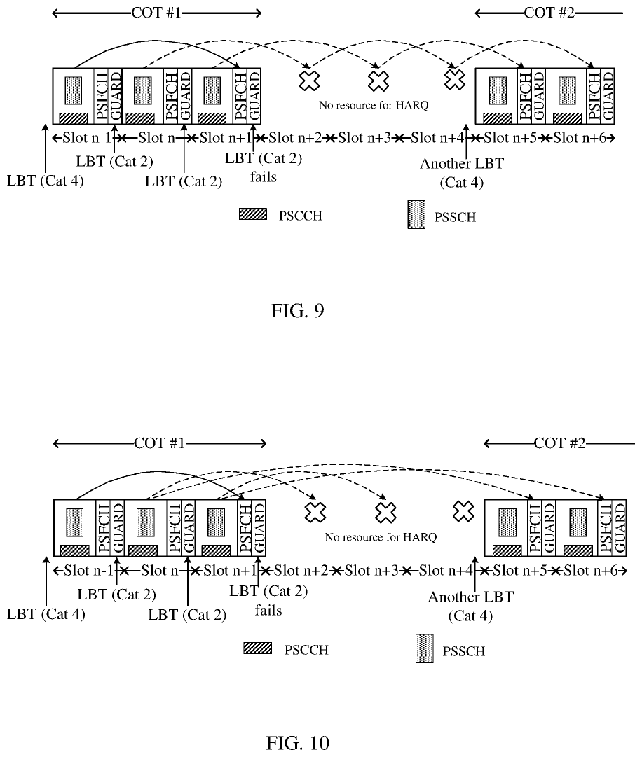

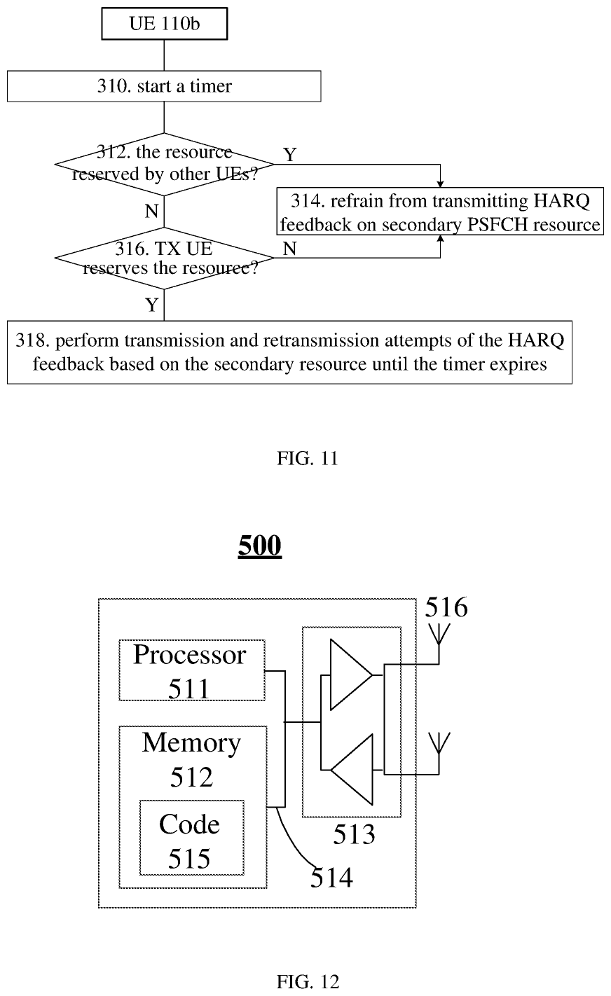

At an operation 222, the TX UE 110a may determine a secondary PSFCH resource for the HARQ feedback that was not transmitted on the primary PSFCH resource. The TX UE 110a may determine the secondary PSFCH resource in the second COT based on predefined rules. For example, the TX UE 110a may determine the secondary PSFCH resource based on the location and number of one or more unavailable (empty) slots between the first COT and the second COT, which will be described below with reference to some examples shown in FIGS. 7 and 9.

Referring to FIG. 7, the PSFCH periodicity is set to N=1 slot and the HARQ delay is set to a=2 slots. The first COT ends at the end of slot n+1 because of LBT failure, and the TX UE 110a initiates the second COT starting from slot n+3. Then the HARQ feedback for the sidelink transmission in slot n cannot be transmitted on the primary PSFCH resource because slot n+2 is unavailable. As an example, the TX UE 110a may determine the secondary PSFCH resource to be in the first available slot n+K+a*x, where n is the slot number of the side transmission of which the primary PSFCH resource is available, K is the configured PSSCH-to-HARQ timing, a is the smallest integer larger than or equal to K, and x is the smallest positive integer satisfying that slot n+K+a*x is within the second COT. The value of x may be determined based on the location and number of empty (unavailable) slots between the first COT and the second CTO initiated by the TX UE 110a. In the example shown in FIG. 7, the secondary PSFCH resource may be determined in slot n+4.

In another example shown in FIG. 9, the TX UE 110a obtains the second COT starting from slot n+5 and other aspects are the same as the example of FIG. 7. In this example, sidelink transmissions in slot n and slot n+1 do not have primary PSFCH resource for HARQ feedbacks as slots n+2 to n+4 are unavailable. Since the second COT starts from slot n+5, the secondary PSFCH resource for the sidelink transmission in slot n may be determined to be in slot n+6 according to the formula n+K+a*x where x is 2 in this example, and the secondary PSFCH resource for the sidelink transmission in slot n+1 may be determined to be in slot n+5 where x is 1.

It would be appreciated that the formula n+K+a*x is only given as an example for determining the secondary PSFCH resources, and other algorithms may also be used. For example, the TX UE 110a may assign a PSFCH-unoccupied slot with a smaller index to an earlier sidelink transmission of which the HARQ feedback is not transmitted. Referring to FIG. 10, HARQ feedback for sidelink transmissions in slots n, n+1 are not delivered, and the PSFCH in slots n+5, n+6 are not occupied. In this case, the TX UE 110a may determine the secondary PSFCH resource for the sidelink transmission in slot n to be in slot n+5, and the secondary PSFCH resource for the sidelink transmission in slot n+1 to be in slot n+6.

Generally, the TX UE 110 can determine vacant PSFCH resources in the second COT based on the location and number of unavailable slots that do not deliver transmissions between the first COT and the second COT, and the vacant PSFCH resources may be used for the secondary PSFCH resources.

Optionally, the TX UE 110a may indicate the secondary PSFCH resource to the RX UE 110b at an operation 224. For example, the TX UE 110a may indicate a slot for the secondary PSFCH resource to the RX UE 110b. The slot may be indicated by e.g. a bitmap [b₀, b₁, . . . b_{y-1}] of y bits where y≥K. The respective bits indicate whether the secondary PSFCH resources exist in slot (b₀), slot (b₁), and so on. For example, in the case shown in FIG. 7, the TX UE 110a may transmit a bitmap [b₀, b₁] to the RX UE 110b in slot n+3, and the bitmap may include b₀=0 and b₁=1, which indicate that the secondary PSFCH resource is not located in the current slot n+3, but in the subsequent slot n+4. In the example shown in FIG. 9, the bitmap [b₀, b₁] may be transmitted to the RX UE 110b in slot n+5 and include b₀=1, b₁=1, which indicate that the secondary PSFCH resources are located in the current slot n+5 and the subsequent slot n+6.

When the bitmap indicates two or more slots including the secondary PSFCH resources, the RX UE 110b may select a slot/secondary PSFCH resource for the HARQ feedback of a given sidelink transmission based on a predefined rule. The predefined rule may be configured or pre-configured at both the TX UE 110a and the RX UE 110b so that they hold the same secondary PSFCH-to-slot mapping. For example, in the case shown in FIG. 9, the bitmap indicates slots n+5, n+6 for the HARQ feedbacks of the sidelink transmissions in slots n, n+1. According to the above-mentioned rule n+K+a*x, the RX UE 110b may select slot n+5 for the HARQ feedback of the sidelink transmission in slot n+1, and slot n+6 for the HARQ feedback of the sidelink transmission in slot n. In the example shown in FIG. 10, the RX UE 110b may select slots n+5, n+6 for the HARQ feedback of the sidelink transmissions in slots n, n+1, respectively. As mentioned above, different rules/algorithms may be applied, but the same rule/algorithm is held at the TX UE 110a and the RX UE 110b.

In some example embodiments, alternatively or additionally, the TX UE 110a may indicate PSFCH occasions to the RX UE 110b, e.g. by a bitmap. For example, the bit b₀ may indicate the first next PSFCH occasion in the current slot or a subsequent slot, the bit b₁ may correspond to the second next PSFCH occasion after the first next PSFCH occasion, and so on. The bitmap may also indicate two or more PSFCH occasions, and the RX UE 110b may select a PSFCH occasion for the HARQ feedback of a given sidelink transmission based on a predefined rule, which may be configured/pre-configured at the TX UE 110a and the RX UE 110b.

In an example embodiment, the secondary PSFCH resource indication may be transmitted to the RX UE 110b on the PSCCH e.g. in the first stage SCI and/or on the PSSCH e.g. in the second stage SCI. The indication may be transmitted in the first slot in the second COT, or in a starting slot of one or more PSFCH-unoccupied slots in the second COT.

In an example embodiment, the secondary PSFCH resource indication may also include an enable/disable bit to indicate whether the previous sidelink transmission(s) of which the HARQ feedback is not delivered needs to/can be acknowledged or not using the secondary PSFCH resources. The RX UE 110b may decide based on the bit to or not to transmit the HARQ feedback of the previous sidelink transmission(s) using the secondary PSFCH resource.

Referring back to FIG. 8, at an operation 226, the RX UE 110b may determine the secondary PSFCH resource for transmitting the HARQ feedback of the sidelink transmission(s) of which the HARQ feedback was not transmitted on the primary PSFCH resource due to e.g. LBT failure. In an example embodiment, the RX UE 110b may determine the secondary PSFCH resource at least partially based on the indication received from the TX UE 110a at the operation 224. For example, the RX UE 110b may determine the slot and/or the PSFCH occasion for the secondary PSFCH resource based on the indication received from the TX UE 110a, and other aspects of the secondary PSFCH resource may depend on the corresponding primary PSFCH Resource. For example, the secondary PSFCH resource mapping may follow the same principles as the primary PSFCH resource mapping, e.g., in the frequency domain and in the code domain.

In another example embodiment, the operation 214 may be omitted, and the RX UE 110b may determine the secondary PSFCH resource on its own. In this example embodiment, the RX UE 110b may determine the secondary PSFCH resource in the time domain following the same principles as the TX UE 110a does at the operation 222, and a repetitive description thereof is omitted here for convenience. Other aspects of the secondary PSFCH resource may depend on the corresponding primary PSFCH Resource. For example, the secondary PSFCH resource mapping may follow the primary PSFCH resource mapping in the frequency domain and in the code domain. As described above, among the I PSFCH resources available for the HARQ feedback of a given transmission, the RX UE 110b may select, for its HARQ feedback, the PSFCH with index i given by i=(T_{ID}+R_{ID}) mod F. By using different cyclic shift pair, different resource block and different Zadoff-Chu sequence, the secondary PSFCH resource determined for a given sidelink transmission may be orthogonal to other primary PSFCH resources for other RX UEs also receiving the given sidelink transmission and orthogonal to primary PSFCH resources corresponding to other sidelink transmissions received at the RX UE 110b from other TX UEs at the same time of receiving the given sidelink transmission. Then at the TX UE 110a side, there will be no PSFCH collision between different RX UEs.

Then at an operation 228, the RX UE 110b may transmit the HARQ feedback to the TX UE 110a using the secondary PSFCH resource. Since the TX UE 110a is also aware of the secondary PSFCH resource, it would monitor for and receive the HARQ feedback on the secondary PSFCH resource.

FIG. 10 illustrates an example procedure for transmitting a HARQ feedback based on the secondary HARQ resource according to an example embodiment of the present disclosure. The procedure may be implemented at the RX UE 110b, and it may be incorporated as a part into the procedure discussed above with respect to FIG. 8.

Referring to FIG. 10, at an operation 310, the RX UE 110b may start a timer to supervise validity of HARQ feedback. In an example, the timer may be started when the RX UE 110b receives a sidelink transmission. If a HARQ feedback is transmitted to the TX UE 110a using the primary PSFCH resource, the RX UE 110b may stop the timer. In another example, the timer may be started at the timing of the primary PSFCH resource when the primary PSFCH resource is detected to be unavailable. The timer may be defined to have a duration of S slots which may be configured/pre-configured at the RX UE 110b or configured by the TX UE 110a or a base station to which the RX UE 110b is connected. The parameter S may have a value of 2, 4, 8, 16, 32 or others.

At an operation 312, when the RX UE 110b has determined the secondary PSFCH resource for a given sidelink transmission, the RX UE 110b may detect whether a different UE has reserved resource in the slot where the secondary PSFCH resource locates with PSFCH mapping identical to the secondary PSFCH resource determined at the RX UE 110b. If yes, the RX UE 110b may refrain from transmitting the HARQ feedback using the secondary PSFCH resource at an operation 314. Otherwise, the procedure may go to an operation 316.

At the operation 316, the RX UE 110b may detect whether the TX UE 110a has reserved resource in the slot where the secondary PSFCH resource locates for a new transmission to the RX UE 110b. If not, the RX UE 110b may refrain from transmitting the HARQ feedback using the secondary PSFCH resource.

If the TX UE 110a has reserved the resource in the slot where the secondary PSFCH resource locates for a new transmission to the RX UE 110b, and no other UE reserves the resource in the slot, the RX UE 110b may perform transmission and retransmission attempts of the HARQ feedback based on the determined secondary PSFCH resource until the timer expires. If the RX UE 110b has not successfully transmitted the HARQ feedback until the timer expires, then the RX UE 110b may abandon the HARQ feedback and flush the HARQ buffer.

FIG. 12 illustrates a schematic block diagram of a device 500 according to an example embodiment of the present disclosure. The device 500 may be implemented as the TX UE 110a and/or the RX UE 110b discussed above.

Referring to FIG. 12, the device 500 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, fiber, optics or other optical communication equipment, and the like. Each of the one or more transceivers 513 may comprise a receiver and a transmitter, which are connected to one or more antennas 516. The device 500 may wirelessly communicate with a network device or a terminal device through the one or more antennas 516. The one or more memories 512 may include computer program code 515. The one or more memories 512 and the computer program code 515 may be configured to, when executed by the one or more processors 511, cause the device 500 to perform operations relating to the TX UE 110a and/or operations relating to the RX UE 110b as described above.

The one or more processors 511 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 511 may be configured to control other elements of the UE/network device and operate in cooperation with them to implement the procedures discussed above.

The one or more memories 512 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 512 may include but not limited to an electric, a magnetic, an optical, an electromagnetic, an infrared, or a semiconductor system, apparatus, or device or any combination of the above.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims

Certain abbreviations that may be found in the description and/or in the figures are herewith defined as follows:
ACK Acknowledgement
CAPC Channel Access Priority Class
CCA Clear Channel Assessment
COT Channel Occupancy Time
CSI Channel State Information
CW Contention Window
HARQ Hybrid Acknowledge Request
LBT Listen Before Talk
NACK Negative Acknowledgement
PSCCH Physical Sidelink Control Channel
PSFCH Physical Sidelink Feedback Channel
PSSCH Physical Sidelink Shared Channel
PRB Physical Resource Block
RRC Radio Resource Control
RX UE Receiver User Equipment
SCI Sidelink Control Information
SL-U Sidelink Unlicensed
TX UE Transmitter User Equipment

1-54. (canceled)

55. An apparatus comprising:
at least one processor; and
at least one memory including computer program code, the at least one memory and the computer program code being configured to, with the at least one processor, cause the apparatus at least to:
receive a sidelink transmission from a user equipment;
determine a hybrid automatic retransmission request, HARQ, feedback regarding the sidelink transmission;
determine a primary resource for transmitting the HARQ feedback is not available; and
determine a secondary resource for transmitting the HARQ feedback.

56. The apparatus of claim 55, wherein determining a primary resource for transmitting the HARQ feedback is not available comprises:
performing a channel assessment procedure to evaluate availability of a channel for transmitting the HARQ feedback.

57. The apparatus of claim 55, wherein determining a secondary resource for transmitting the HARQ feedback comprises:
determining the secondary resource at least partially based on an indication of the secondary resource received from the user equipment.

58. The apparatus of claim 57, wherein the indication of the secondary resource indicates a slot and/or a physical sidelink feedback channel occasion for the secondary resource.

59. The apparatus of claim 58, wherein the at least one memory and the computer program code are further configured to, with the at least one processor, cause the apparatus at least to:
select a slot and/or a physical sidelink feedback channel occasion from a plurality of slots and/or a plurality of physical sidelink feedback channel occasions based on a first predefined rule when the indication of the secondary resource indicates the plurality of slots and/or the plurality of physical sidelink feedback channel occasions.

60. The apparatus of claim 55, wherein determining a secondary resource for transmitting the HARQ feedback comprises:
determining the secondary resource at least partially based on a second predefined rule.

61. The apparatus of claim 60, wherein the second predefined rule determines a slot for the secondary resource based on a location and a number of one or more unavailable slots between first channel occupancy time shared by the user equipment for receiving the sidelink transmission and a subsequent second channel occupancy time shared by the user equipment.

62. The apparatus of claim 60, wherein the at least one memory and the computer program code are further configured to, with the at least one processor, cause the apparatus at least to:
detect whether another user equipment reserves resource in a slot where the secondary resource locates with physical sidelink feedback channel resource mapping identical to the secondary resource; and
refrain to transmit the HARQ feedback using the secondary resource when the another user equipment reserves the resource in the slot where the secondary resource locates.

63. The apparatus of claim 60, wherein the at least one memory and the computer program code are further configured to, with the at least one processor, cause the apparatus at least to:
detect whether the user equipment reserves resource in a slot where the secondary resource locates for an additional sidelink transmission to the apparatus; and
transmit the HARQ feedback using the secondary resource when the user equipment reserves the resource in the slot where the secondary resource locates.

64. The apparatus of claim 55, wherein the secondary resource depends on the primary resource in frequency and/or code domain.

65. The apparatus of claim 55, wherein the secondary resource is orthogonal to other primary resources for other user equipments receiving the sidelink transmission or to primary resources corresponding to other sidelink transmissions received at the apparatus from other user equipments.

66. The apparatus of claim 55, wherein the at least one memory and the computer program code are further configured to, with the at least one processor, cause the apparatus at least to:
start a timer at a timing of the primary resource or when the sidelink transmission is received; and
perform transmission and retransmission attempts of the HARQ feedback based on the secondary resource until the timer expires.

67. An apparatus comprising:
at least one processor; and
at least one memory including computer program code, the at least one memory and the computer program code being configured to, with the at least one processor, cause the apparatus at least to:
transmit a sidelink transmission to a user equipment;
determine a primary resource for receiving a hybrid automatic retransmission request, HARQ, feedback regarding the sidelink transmission is not available; and
determine a secondary resource for receiving the HARQ feedback.

68. The apparatus of claim 67, wherein determining a primary resource for receiving an HARQ feedback regarding the sidelink transmission is not available comprises:
performing a channel assessment procedure to evaluate availability of a channel for receiving the HARQ feedback.

69. The apparatus of claim 67, wherein the at least one memory and the computer program code are further configured to, with the at least one processor, cause the apparatus at least to:
transmit an indication of the secondary resource to the user equipment.

70. The apparatus of claim 69, wherein the indication of the secondary resource indicates a slot and/or a physical sidelink feedback channel occasion for the secondary resource.

71. The apparatus of claim 70, wherein the indication of the secondary resource includes a plurality of slots and/or a plurality of physical sidelink feedback channel occasions, the slot and/or the physical sidelink feedback channel occasion for the secondary resource are indicated in the indication based on a first predefined rule.

72. The apparatus of claim 69, wherein the indication of the secondary resource indicates whether the user equipment needs to transmit the HARQ feedback.

73. The apparatus of claim 69, wherein the indication of the secondary resource is transmitted on a physical sidelink control channel and/or a physical sidelink shared channel.

74. A method for sidelink communication comprising:
receiving at an apparatus a sidelink transmission from a user equipment;
determining a hybrid automatic retransmission request, HARQ, feedback regarding the sidelink transmission;
determining a primary resource for transmitting the HARQ feedback is not available; and
determining a secondary resource for transmitting the HARQ feedback.
